(19) United States
(12) Patent Application Publication
(10) Pub. No.: US 2012/0098974 A1
(43) Pub. Date: Apr. 26, 2012

(54) OPTICAL METHOD FOR MEASURING HEIGHT OF FLUORESCENT PHOSPHOLIPID FEATURES FABRICATED VIA DIP-PEN NANOLITHOGRAPHY

(75) Inventors: STEVEN LENHERT, Tallahassee, FL (US); Omkar A. Nafday, Tallahassee, FL (US)

(73) Assignee: Florida State University Research Foundation, Tallahassee, FL (US)

(21) Appl. No.: 13/234,540

(22) Filed: Sep. 16, 2011

Related U.S. Application Data
(60) Provisional application No. 61/383,775, filed on Sep. 17, 2010.
(60) Provisional application No. 61/384,764, filed on Sep. 21, 2010.

(51) Int. Cl. H04N 17/00; B05D 5/06; B32B 3/10

(52) U.S. Cl. 348/180; 428/207; 428/206; 427/157; 348/E17.001

(57) ABSTRACT

Described is a calibration standard for determining the height of fluorescent microstructures, methods of using such a calibration standard, and a method of making such a calibration standard.

### CROSS-REFERENCE TO RELATED APPLICATIONS

This application claims benefit of priority to U.S. Provisional Patent Application No. 61/383,775 to Lenhert et al., entitled “OPTICAL METHOD FOR MEASURING HEIGHT OF FLUORESCENT PHOSPHOLIPID FEATURES FABRICATED VIA DIP-PEN NANOLITHOGRAPHY (DPN),” filed Sep. 17, 2010, and U.S. Provisional Application No. 61/384,764 to Lenhert et al., entitled “A CALIBRATION STANDARD FOR A FLUORESCENCE MICROSCOPE, A METHOD OF MAKING SUCH A CALIBRATION STANDARD AND A METHOD OF CALIBRATING USING SUCH A STANDARD,” filed Sep. 21, 2010, the entire content and disclosures of which are incorporated by reference in its entirety.

### BACKGROUND

1. Field of the Invention

The present invention relates to a calibration standard for microstructures.

2. Related Art

Surface supported phospholipid multilayers are promising materials for nanotechnology because of their tendency to self-organize, their innate biocompatibility, the possibility to encapsulate other materials within the multilayers, and the ability to control the multilayer thickness between ˜2 and 100 nm during fabrication. Dip-pen nanolithography (DPN) is an atomic force microscopy (AFM) based fabrication method that allows high-throughput fabrication and integration of a variety of microstructured and nanostructured materials including lipid multilayers, with areal throughputs on the scale of cm² min⁻¹. Although multilayer thickness is an important feature that determines the functionality of the lipid multilayer structures (for instance as carriers for other materials as well as optical scattering properties), reliable height characterization by AFM is slow (on the order of μm² min⁻¹) and a bottleneck in the lithographic process.

### SUMMARY

According to a first broad aspect, the present invention provides a device comprising: a substrate, and one or more patterned arrays of fluorescent microstructures on the substrate, wherein each of the one or more patterned arrays of fluorescent microstructures comprises fluorescent microstructures having the same shape and two or more different heights.

According to a second broad aspect, the present invention provides a method comprising the following steps: (a) calibrating a camera based on a calibration profile, (b) detecting with the calibrated camera fluorescent intensities of one or more fluorescent microstructures of a sample, and (c) determining a height of each of one or more fluorescent microstructures of the sample based on the fluorescent intensities detected in step (b), wherein the calibration profile is based on fluorescence intensities detected by the camera for one or more patterned arrays of standard fluorescent microstructures of a calibration standard, and wherein each of the patterned arrays of standard fluorescent microstructures comprises fluorescent microstructures having the same shape and two or more different heights.

According to a third broad aspect, the present invention provides a method comprising the following steps: (a) detecting with a camera fluorescent intensities of one or more fluorescent microstructures of a sample, and (b) determining a height of each of the one or more fluorescent microstructures based on the fluorescent intensities detected in step (a) and a calibration profile for the camera, wherein the calibration profile is based on fluorescence intensities detected by the camera for one or more patterned arrays of standard fluorescent microstructures of a calibration standard, and wherein each of the patterned arrays of fluorescent microstructures comprises fluorescent microstructures having the same shape and two or more different heights.

According to a fourth broad aspect, the present invention provides a method comprising the following steps: (a) providing a substrate, and (b) depositing one or more patterned arrays of fluorescent microstructures on the substrate, wherein each of the patterned array of fluorescent microstructures comprises fluorescent microstructures having the same shape and two or more different heights.

### BRIEF DESCRIPTION OF THE DRAWINGS

The accompanying drawings, which are incorporated herein and constitute part of this specification, illustrate exemplary embodiments of the invention and, together with the general description given above and the detailed description given below, serve to explain the features of the invention.

FIG. 1 shows the chemical structures of 1,2-dioleoyl-sn-glycero-3-phosphocholine (DOPC), a phospholipid, and 1,2-dioleoyl-sn-glycero-3-phosphoethanolamine-N-(lissamine rhodamine B sulfonyl) (DOPE-RB) used to make arrays of fluorescent microstructures according to one embodiment of the present invention.

FIG. 2 shows fluorescent microstructures being excited using light transmitted through a microscope objective lens and the fluorescent microstructures emitting light in response according to one embodiment of the present invention.

FIG. 3 is a graph of emitted light intensity vs. height for three hypothetical fluorescent microstructure dots according to one embodiment of the present invention.

FIG. 4 is a fluorescent microscopy image of 6×3 DOPC dot arrays (15 μm pitch) created with M type cantilevers.

FIG. 5 is a graph of emitted light intensity vs. exposure time curve for a 227 nm tall dot indicated by an arrow on FIG. 4.

FIG. 6 is an atomic force microscopy (AFM) height image of one of the dot arrays (dot radii 640 nm to 2.5 μm) enclosed in a white rectangle of FIG. 4 and having dot heights ranging from 14 to 356 nm.

FIG. 7 is a sensitivity vs. dot height calibration curve for all the dot heights measured in the white rectangle of FIG. 4 with each of the data points in this figure being obtained by plotting the slope vs. the height measured with AFM.

FIG. 8 is a plot of calibration curves obtained for three feature shapes: dots, lines and squares of an array of fluorescent microstructures according to one embodiment of the present invention.

FIG. 9 is a fluorescent microscope image of a large area (0.12 mm²) FSU pattern created by moving the DOPC coated tip at a tip speed of 75 nm/s.

FIG. 10 is a close-up image of the one of the FSU letters enclosed by the white square in FIG. 9.

FIG. 11 is an intensity profile of the FSU letters at the region of the white line, registering a value of 115 which is equivalent to a height of 170 nm.

FIG. 12 is an AFM height image of the same FSU logo of FIG. 10 with a measurement performed at the same location of the white line as shown in FIG. 10.

FIG. 13 is a height trace showing a value of 177 nm for the “F” letter of FIG. 12.

FIG. 14 is a fluorescent micrograph of line patterns drawn with doped DOPC ink by moving the tip at a speed of 100 nm/s with the lines being 20 μm long.

FIG. 15 is an AFM height image of the lines enclosed by the white square in FIG. 14, imaged in alternate contact mode.

FIG. 16 is a graph of sensitivity vs. a line height calibration curve obtained using the slope (grey values/s) of each line height with an inset graph showing a typical linear relationship observed between the exposure time (s=seconds) and intensity (grey values) registered for a 156 nm tall line.

FIG. 17 is a fluorescent micrograph of square patterns drawn with doped DOPC ink.

FIG. 18 is an AFM height image of the square enclosed by the white square in FIG. 17 imaged in alternate contact mode.

FIG. 19 is a graph of sensitivity vs. line height calibration curve obtained using the slope (grey values/s) of each line height with an inset graph showing a typical linear relationship observed between the exposure time (s) and intensity (grey values) registered for a 187 nm tall square.

### DETAILED DESCRIPTION OF THE PREFERRED EMBODIMENTS

### Definitions

Where the definition of terms departs from the commonly used meaning of the term, applicant intends to utilize the definitions provided below, unless specifically indicated.

For purposes of the present invention, it should be noted that the singular forms, “a,” “an,” and “the” include reference to the plural unless the context as herein presented clearly indicates otherwise.

For purposes of the present invention, directional terms such as “top,” “bottom,” “upper,” “lower,” “above,” “below,” “left,” “right,” “horizontal,” “vertical,” “up,” “down,” etc. are merely used for convenience in describing the various embodiments of the present invention. The embodiments of the present invention may be oriented in various ways. For example, the diagrams, apparatuses, etc. shown in the drawing figures may be flipped over, rotated by 90° in any direction, reversed, etc.

For purposes of the present invention, a value or property is “based” on a particular value, property, the satisfaction of a condition, or other factor, if that value is derived by performing a mathematical calculation or logical decision using that value, property or other factor.

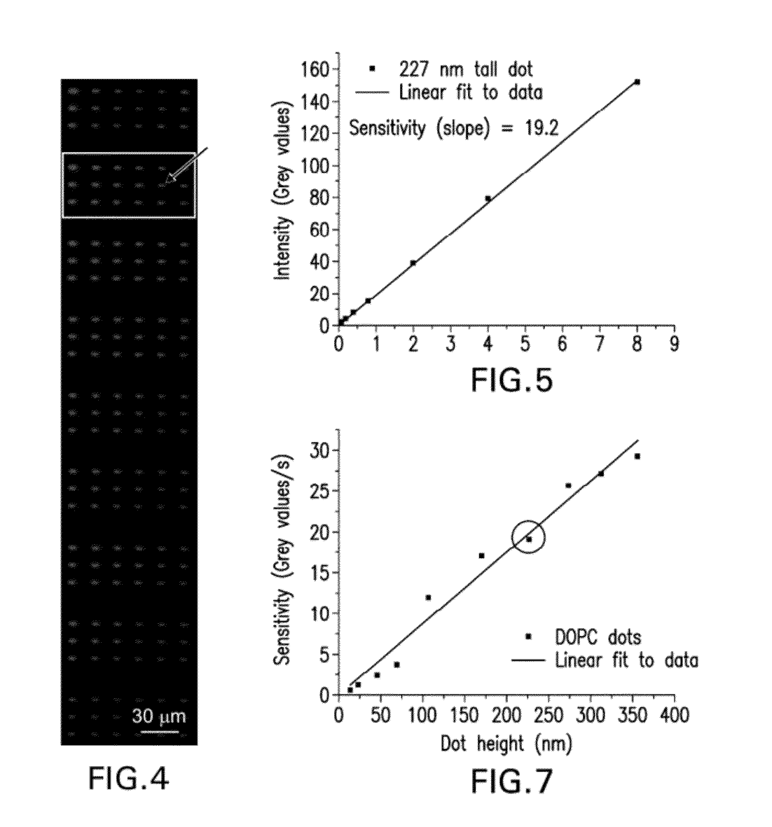

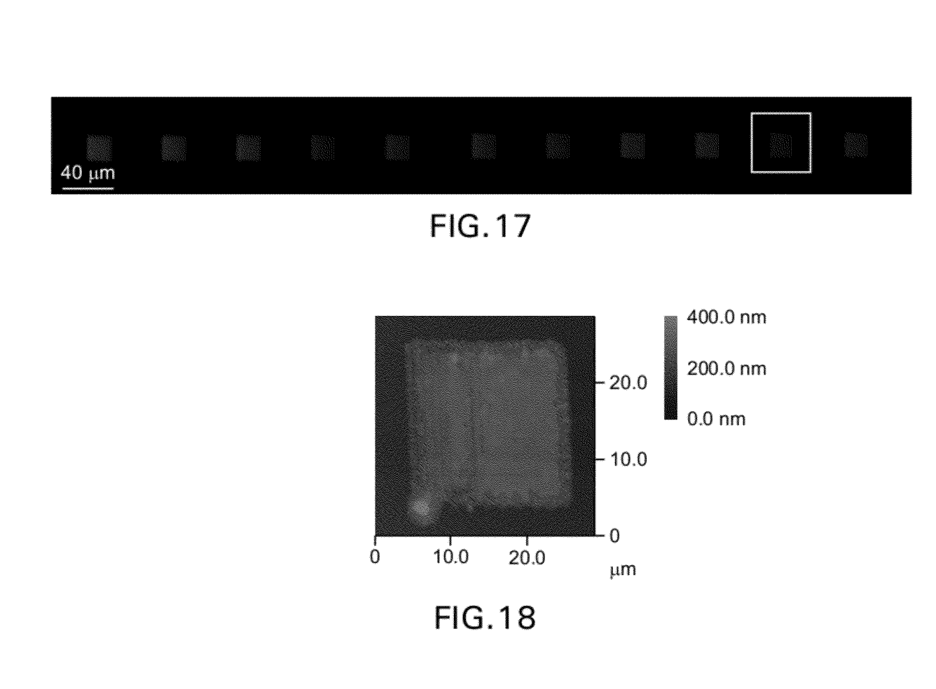

For purposes of the present invention, the term “array” refers to a one dimensional or two dimensional set of microstructures. An array may be any shape. For example, an array may be a series of microstructures arranged in a line, such as the array of squares shown in FIG. 17. An array may be arranged in a square or rectangular grid, such as the array of dots shown in FIG. 4. There may be sections of the array that are separated from other sections of the array by spaces, such as the array of dots shown in FIG. 4 in which there are “sections,” i.e., rectangular grid arrays of dots, that are separated from each other by regular spacing. An array may have other shapes. For example, an array may be a series of microstructures arranged in a series of concentric circles, in a series of concentric squares, a series of concentric triangles, a series of curves, etc. The spacing between sections of an array or between microstructures in any array may be regular or may be different between particular sections or between particular pairs of microstructures.

For purposes of the present invention, the term “biomolecule” refers to the conventional meaning of the term biomolecule, i.e., a molecule produced by or found in living cells, e.g., a protein, carbohydrate, lipid, a phospholipid, a nucleic acid, etc.

For purposes of the present invention, the term “calibration profile” refers to one or more calibration curves based on intensity data for one or more respective arrays of fluorescent microstructures in which the fluorescent microstructures for each array have the same shape and two or more different heights. Within an array of microstructures that is used to obtain a calibration profile, two or more fluorescent microstructures may have the same height. The calibration curves and calibration profile may be adjusted based on the differences between the measured heights of the fluorescent microstructures of the arrays of the calibration standard and the heights determined from the calibration determined solely by the fluorescence intensities detected by the camera, including detection at different exposure conditions, such as exposure time, lamp intensities, light path adjustments, hardware or software gain, etc. for the fluorescent microstructures of the arrays of the calibration standard.

For purposes of the present invention, the term “calibration standard” refers to one or more arrays of fluorescent microstructures on a substrate in which one or more of the fluorescent microstructures have known or predetermined heights. The heights of the fluorescent microstructures of the one or more arrays a calibration standard may be measured by various means to determine the height of one or more of the fluorescent microstructures and this information may be recorded for this calibration standard. A camera may be used to determine the heights of the fluorescent microstructures of the one or more arrays of the calibration standard to generate calibration curves and a calibration profile for the calibration standard for that camera or camera type. The calibration curves and calibration profile may be adjusted based on the differences between the measured heights of the fluorescent microstructures of the arrays of the calibration standard and the heights determined from the calibration determined by the fluorescence intensities detected by the camera for the fluorescent microstructures of the arrays of the calibration standard.

For purposes of the present invention, the term “camera” refers to any type of camera or other device that senses light intensity. Examples of cameras include digital cameras, scanners, charged-coupled devices, CMOS sensors, photomultiplier tubes, analog cameras such as film cameras, etc. A camera may include additional lenses and filters such as the lenses of a microscope apparatus that may adjusted when the camera is calibrated.

For purposes of the present invention, the term “dot” refers to a microstructure that has a zero-dimensional shape.

For purposes of the present invention, the term “fluorescence” refers to the conventional meaning of the term fluorescence, i.e., the emission of light by a substance that has absorbed light or other electromagnetic radiation of a different wavelength.

For purposes of the present invention, the term “fluorescent” refers to any material or mixture of materials that exhibits fluorescence.

For purposes of the invention, the term “fluorescent dye” refers to any substance or additive that is fluorescent or imparts fluorescence to another material. A fluorescent dye may be organic, inorganic, etc.

For purposes of the present invention, the term “fluorescent microstructure” refers to a microstructure that is fluorescent. A fluorescent microstructure may be made of a naturally fluorescent material or may be made of a nonfluorescent material, such as a phospholipid, doped with a fluorescent dye.

For purposes of the present invention, the term “fluorescent nanostructure” refers to a nanostructure that is fluorescent. A fluorescent nanostructure may be made of a naturally fluorescent material or may be made of a nonfluorescent material, such as a phospholipid, doped with a fluorescent dye.

For purposes of the present invention, the term “hardware and/or software” refers to functions that may be performed by digital software or digital hardware, or a combination of both digital hardware and digital software.

For purposes of the present invention, the term “height” refers to the maximum thickness of the microstructure on a substrate, i.e., the maximum distance the microstructure projects above the substrate on which it is located.

For purposes of the present invention, the term “line” refers to “line” as this term is commonly used in the field of nanolithography to refer to a one-dimensional shape.

For purposes of the present invention, the term “microstructure” refers to a structure having at least one dimension smaller than 1 mm. A nanostructure is one type of microstructure.

For purposes of the present invention, the term “nanostructure” refers to a structure having at least one dimension on the nanoscale, i.e., a dimension between 0.1 and 100 nm.

For purposes of the present invention, the term “patterned” refers to an array that is organized in predetermined pattern as opposed to randomly.

For purposes of the present invention, the term “plurality” refers to two or more. So an array of microstructures having a “plurality of heights” is an array of microstructures having two or more heights. However, some of the fluorescent microstructures in an array having a plurality of heights may have the same height.

For purposes of the present invention, the term “square” refers to a microstructure that is square in shape, i.e. has two-dimensional shape wherein all sides are equal. Although the experiments discussed below in the Example for two-dimensional shapes for microstructures that were squares, the present invention may also be used with other two-dimensional shapes such as rectangles, circles, parallelograms, pentagons, hexagons, etc.

### DESCRIPTION

Phospholipids in biological systems form the bilayer structure of cellular membranes, as well as a variety of multilayer structures. Examples of lipid multilayers in biological systems include multilamellar cristae in the mitochondria, thylakoid grana and the cisternae of the Golgi apparatus and endoplasmic reticulum. Synthetic phospholipid multilayers can be fabricated by spin-coating, see Mathieu M, Schunk D, Franzka S, Mayer C and Hartmann N 2010 J. Vac. Sci. Technol. A 28 953; Mennicke U and Salditt T 2002 Langmuir 18 8172; controlling hydration between glass slides, see Trapp M, Gutberlet T, Juranyi F, Unruh T, Deme B, Tehei M and Peters J 2010 J. Chem. Phys. 133 164505 Eggeling C et al 2009 Nature 457 1159; Langmuir-Blodgett deposition, see Pompeo G, Girasole M, Cricenti A, Cattaruzza F, Flamini A, Prosperi T, Generosi J and Castellano A C 2005 Biomembranes 1712 29; laser writing, see Scheres L, Klingebiel B, ter Maat J, Giesbers M, de Jong H, Hartmann N and Zuilhof H 2010 Small 6 1918; dewetting, see Le Berre M, Chen Y and Baigl D 2009 Langmuir 25 2554; Diguet A, Le Berre M, Chen Y and Baigl D 2009 Small 5 1661; and dip-pen nanolithography (DPN), see Lenhert S, Sun P, Wang Y H, Fuchs H and Mirkin C A 2007 Small 3 71, and the entire contents and disclosures of the above articles are incorporated herein by reference.

In particular, the ability to control the multilayer thickness by the fabrication technique is an important attribute that determines the functionality of lipid multilayers. For example, the efficiency of optical diffraction from lipid multilayer gratings depends on the multilayer thickness, which is a critical factor in their application as model cellular systems and label-free biological sensors, see Tanaka M and Sackmann E 2005 Nature 437 656; and Anrather D, Smetazko M, Saba M, Alguel Y and Schalkhammer T 2004 J. Nanosci. Nanotechnol. 4 1, the entire contents and disclosures of which are incorporated herein by reference.

DPN has emerged as a reliable method for creating microstructures with a wide variety of materials on desired surfaces, see Lenhert S et al 2010 Nat. Nanotechnol. 5 275; Braunschweig A B, Huo F W and Mirkin C A 2009 Nat. Chem. 1 353; Lenhert S, Fuchs H and Mirkin C A 2009 Materials Integration by Dip pen Nanolithography (Weinheim: Wiley-VCH); Zhang H, Amro N, Disawal S, Elghanian R, Shile R and Fragala J 2007 Small 3 81; Li B, Goh C F, Zhou X Z, Lu G, Tantang H, Chen Y H, Xue C, Boey F Y C and Zhang H 2008 Adv. Mater. 20 4873; Li H, He Q Y, Wang X H, Lu G, Liusman C, Li B, Boey F, Venkatraman S S and Zhang H 2011 Small 7 226; Salaita K, Wang Y H and Mirkin C A 2007 Nat. Nanotechnol. 2 145; Haaheim J and Nafday O N 2008 Scanning 30 137; and Ginger D S, Zhang H and Mirkin C A 2004 Angew. Chem. Int. Edn 43 30, the entire contents and disclosures of which are incorporated herein by reference. Using phospholipids as the ink for DPN allows control of the lipid multilayer stacking (height) and biocompatible material integration on solid surfaces, see Sekula S et al 2008 Small 4 1785; and Wang Y H, Giam L R, Park M, Lenhert S, Fuchs H and Mirkin C A 2008 Small 4 1666, the entire contents and disclosures of which are incorporated herein by reference.

The resulting biomimetic lipid structures may have use as cell-surface models, biochemical sensors, drug screening and delivery vehicles, for analysis of cell-cell interactions, and to elucidate the mechanisms of membrane trafficking. Lipid multilayer structures have been fabricated using both serial and massively parallel DPN modes, allowing throughputs on the scale of cm² min⁻¹. The height of phospholipid structures can be tuned by the tip contact time and controlling the relative humidity of the patterning environment in DPN, see Lenhert S, Sun P, Wang Y H, Fuchs H and Mirkin C A 2007 Small 3 71, the entire contents and disclosure of which are incorporated herein by reference.

Quality control is a crucial step in any nanofabrication process, as is well known from the semiconductor, chemical and biomedical industries. Parallel DPN is a high-throughput nanofabrication method based on atomic force microscopy (AFM), and AFM is traditionally used for quality control of DPN-fabricated structures. AFM imaging is an established and often essential method of microstructure characterization because of its high lateral and topographical resolution, but, compared to that of optical methods, its throughput is severely limited. As a quality-control method AFM cannot keep up with the throughput of DPN fabrication. One approach to DPN uses solid, molecular inks (such as alkanethiols on gold) that form topographically smooth monolayers with sub-100 nm lateral resolution. In the case of direct deposition of biological molecules, fluid inks are typically used, especially for direct deposit of biological materials such as DNA, protein and lipids, see Lenhert S, Sun P, Wang Y H, Fuchs H and Mirkin C A 2007 Small 3 71; Demers L M, Ginger D S, Park S J, Li Z, Chung S W and Mirkin A 2002 Science 296 1836; Lee K B, Lim J H and Mirkin C A 2003 J. Am. Chem. Soc. 125 5588; and Huang L, Braunschweig A B, Shim W, Qin L D, Lim J K, Hurst S J, Huo F W, Xue C, Jong J W and Mirkin C A 2010 Small 6 1077, the entire contents and disclosures of which are incorporated by reference. In the case of fluid inks, lateral resolution is often around 500 nm (with the possibility to reduce it below 100 nm when needed), yet with a level of volume control that enables single particle printing when materials are delivered in a matrix, see Bellido E, deMiguel R, Ruiz-Molina D, Lostao A and Maspoch D 2010 Adv. Mater. 22 352, the entire contents and disclosure of which are incorporated herein by reference. Pattern thickness is therefore a critical parameter in quality control of samples fabricated by fluid DPN.

In one embodiment the present invention provides a method for reliably measuring the heights of fluorescent multilayer features fabricated by DPN. In this method DPN is to fabricate calibration standards having arrays of fluorescent microstructures with various shapes, sizes and heights. By relating the fluorescence intensity of the fluorescent microstructures to the AFM height measurements, it is possible obtain calibration curves that can be used for high-throughput sample characterization and quantitative quality control by optical methods. These calibration curves may then be used to determine patterned microstructure height over large areas without the use of time-consuming AFM image collection. A fluorescence intensity-based structure-height quantification approach also may be useful current and emerging nanofabrication methods such as the systematic characterization of fluorescent micro- and nanostructures for manufacturing and the rapid screening of microstructure-function and nanostructure-function relationships.

In one embodiment, the present invention provides an optical method to reliably measure the height of fluorescent multilayers with thicknesses above 10 nm and widths above the optical diffraction limit based on calibrating the fluorescence intensity using one-time AFM height measurements. This allows large surface areas to be rapidly and quantitatively characterized using a standard fluorescence microscope. Importantly, different pattern dimensions such as 0D dots, 1D lines or 2D squares require different calibration parameters, indicating that shape influences the optical properties of the structured lipid multilayers. This method has general implications in the systematic and high-throughput optical characterization of microstructure-function and nanostructure-function relationships.

Although multilayer thickness is a critical feature that determines the functionality of the lipid multilayer structures (for instance as carriers for other materials as well as optical scattering properties), reliable height characterization by AFM is slow (on the order of μm² min⁻¹) and a bottleneck in the lithographic process. In one embodiment, the present invention provides an optical method that may be used to reliably measure the height of fluorescent multilayers with thicknesses above 10 nm and widths above the optical diffraction limit based on calibrating the fluorescence intensity using one-time AFM height measurements. This allows large surface areas to be rapidly and quantitatively characterized using a standard fluorescence microscope. Importantly, different pattern dimensions, such as 0D dots, 1D lines or 2D squares, require different calibration parameters, indicating that shape influences the optical properties of the structured lipid multilayers. This method has general implications in the systematic and high-throughput optical characterization of microstructure-function and nanostructure-function relationships.

Optical characterization by quantification of emitted or reflected light has been demonstrated in the context of a wide variety of fields, for example DNA and protein microarrays, chemical sensors, estimation of section thickness, 3D inspection, and measurement of critical dimensions of silicon processing. A number of calibration methods and measurement techniques have also been introduced for visual measurement systems based on optical, fluorescence, confocal and interference microscopy. In particular, approaches based on the linear relationship between fluorophore film thickness and fluorescence intensity has been successfully implemented for determination of organic residue on printed wiring boards, measurement of the thickness of photoresist films on a substrate, and use of wax films doped with rhodamine to determine film thickness by laser profilometry. Surface topography has been measured optically by immersion of the sample in a solution containing a strongly absorbing dye and measurement of transmission at the wavelength where the dye absorbs. Further examples of methods for optical characterization include the development of nanoscale markers, and fabrication of calibration standards for biological fluorescence microscopy. However, none of these prior methods of optical characterization has involved different calibration curves for measuring the height of different shaped structures.

In one embodiment, the present invention provides an approach suitable both for the fabrication of calibration standards and for high-throughput characterization of fluorescent micro- and nanostructures created by emerging nanofabrication methods such as DPN. Image calibration and measurement of structures (especially biological structures) in the context of fluorescence microscopy are typically based on reading the intensity and location of the fluorescent structures with CCD cameras. The signal from the CCD camera is measured in terms of grey values (e.g., 0-255 for an eight-bit image), which are indications of the numbers of photons reaching the camera from the fluorophore-doped structure. Practical implementation of quantitative microscopy requires conversion of the fluorescence intensity to absolute units (e.g., the number of molecules in a particular structure) and generating calibration curves. While generating calibration curves, it is important to account for the precision of fluorescence intensity estimation and the impact of background intensity. The measurement precision (noise) of a digital microscope can be estimated from a standard slide made with uniformly fluorescent polystyrene beads or a piece of fluorescent plastic.

In one embodiment of the present invention, DPN is used to fabricate structured fluorescent standards (dots, lines, and squares of various heights). Correlations of the fluorescence intensities of the structures with the feature heights measured by AFM produced a high-throughput optical quality-control approach suitable for these types of structures. An advantage of some embodiments of the method of the present invention is that it eliminates the need for repetitive AFM scanning, is a truly nonintrusive approach especially suitable for soft biomolecules such as phospholipids and other similar molecules, can be extended to transparent structures of irregular shape, and lends itself to custom creation of calibration standards for a particular nanofabrication system.

In one embodiment of the present invention, a calibration standard of the present invention may be formed by depositing a patterned array of fluorescent microstructures using dip-pen lithography techniques, such as the dip-pen lithography techniques described above.

In one embodiment the calibration standard comprises a substrate and a single patterned array of fluorescent microstructures of a single shape and having different heights, although two or more fluorescent microstructures of the patterned array may have different heights.

The patterned array of fluorescent microstructures may comprise a single patterned array of fluorescent microstructures or two or more patterned array of microstructures. Examples of patterned array of fluorescent microstructures are a patterned array of dots, a patterned array of lines, a patterned array of squares, etc.

In one embodiment, the calibration standard may comprise a patterned array of quantum dots to reduce bleaching.

Although microstructures having the shapes of dots, lines and squares are described above, the fluorescent microstructures of the present invention may have a variety of shapes.

The fluorescent microstructures of the present invention may be made of any material or mixture of materials that is fluorescent or that may be made fluorescent using a suitable dye. In one embodiment, the fluorescent microstructures of the present invention may comprise one or more naturally fluorescent biomolecules or one or more biomolecules to which a fluorescent dye has been added. The biomolecules used in the fluorescent microstructures of the present invention may be any type of biomolecule such as a protein, carbohydrate, lipid, a phospholipid, a nucleic acid, etc.

Although one type of fluorescent dye is described as being used to make a microstructure fluorescent above, various types of fluorescent additives may be used to make a microstructure a fluorescent microstructure. Examples of suitable fluorescent dyes include various fluorescent organic molecules, fluorescent proteins, pigments, nanoparticles, etc.

The substrate of the present invention may be virtually any type of substrate on which nanonostructures may be grown such as glass, plastic, paper, a semiconductor material, etc.

In one embodiment of the present invention, a calibration standard of the present invention may be used in the following manner to determine the heights of microstructures in a sample. The camera is used to detect the fluorescent intensities for a patterned array of the standard fluorescent microstructures of a calibration standard. A calibration profile is then generated for the camera by hardware and/or software of the camera or from a computer, laptop computer, tablet computer, an electronic device, an electronic instrument, etc. The camera is calibrated using the calibration profile. The calibrated camera is then used to detect the fluorescent intensities of one or more fluorescent microstructures of a sample. Based on the fluorescent intensities detected by the camera, the height of each of the structures of the fluorescent microstructures on the sample may be determined.

In one embodiment of the present invention, a calibration standard of the present invention may be used in the following manner to determine the heights of microstructures in a sample. The camera is used to detect the fluorescent intensities for a patterned array of the standard fluorescent microstructures of a calibration standard. A calibration profile is then generated for the camera by hardware and/or software of the camera or from a computer or another electronic device. The calibrated camera is then used to detect the fluorescent intensities of one or more fluorescent microstructures of a sample. Based on the fluorescent intensities detected by the camera and the calibration profile, the height of each of the structures of the fluorescent microstructures on the sample may be determined.

For more accurate measurements, the temperature of the camera should be about the same when detecting fluorescent intensities for the fluorescent microstructures of the calibration standard and when detecting the fluorescent intensities for the fluorescent microstructures of the sample.

### Example

Materials and Procedures. 1,2-dioleoyl-sn-glycero-3-phosphocholine (DOPC, 20 g L⁻¹ solution in chloroform) and 1,2-dioleoyl-sn-glycero-3-phosphoethanolamine-N-lissamine rhodamine B sulfonyl (DOPERB, 1 g L⁻¹ solution in chloroform) from Avanti Polar Lipids, Inc. (Alabaster, Ala.), and used as received. Rhodamine B (RB) is an orange dye with an excitation wavelength of 557 nm and an emission of 571 nm that is imaged with a Nikon G-2E/C filter set. It is known to produce a fluorescent field of reproducible intensity with a good resistance to photo-bleaching at low excitation power. A 1 mol % solution of DOPE-RB is prepared in DOPC, and the mixture is pipetted into an inkwell delivery system made by NanoInk, Inc. (Skokie, Ill.), for tip inking. This ink formulation is used throughout the study reported here unless stated otherwise. The inkwell is kept under vacuum overnight so that the chloroform would evaporate. The inks are kept in closed tins to prevent their exposure to external light sources. F- and M-type 1D cantilever arrays (NanoInk, Inc.) are used for DPN. These arrays ware dipped into the inkwell microchannels for 5 min to coat the tip with DOPC ink. Glass slides (No. 48366-227 from VWR (West Chester, Pa.) and oxygen plasma cleaned for 2 min at low power just before DPN. All experiments are performed at ambient relative humidity (53±3%) and temperature (25±2° C.). A Ti-E epifluorescence inverted microscope (Nikon Instruments, Inc., Melville, N.Y.) fitted with a Retiga SRV (Qlmaging, Canada) CCD camera (1.4 megapixel, Peltier cooled to −45° C.) is used to image the fluorescent patterns created. All images for generation of intensity-by-height calibration curves are captured at the lowest gain setting with no binning with a Nikon 10× objective lens (645 nm/pixel, numerical aperture (NA)=0.3) with different exposure times. These images are then saved in their native 16-bit tiff black-and-white format and analyzed with ImageJ software. In ImageJ, the images were converted to eight-bit format, 256 grey values (the brightest, saturated regions had the maximum intensity of 255 grey values). The images with different exposure times are merged into a stack of images with different exposure times (0.2 ms-8 s). For measurement of fluorescence intensity of the dot features, a region of interest (ROI) is drawn around the dot in ImageJ, and the intensity of the brightest pixel in the dot is measured and analyzed with the ‘plot Z axis profile’ function in the stacks menu of ImageJ. For line features, rectangular ROIs (one pixel wide) were drawn perpendicular to the line, and the maximum intensity of the line cross section is measured as described for the dot measurements above. Three cross sections are measured per line, and the average of the three cross-section maxima are taken as the intensity for the line. In the case of square features, square ROIs were drawn just inside the perimeter of the patterned square feature, and an average is taken over the ROI area. As the exposure times decreases, the images become less bright and eventually disappeared into the background, as expected. After fluorescence microscope imaging, the patterns were imaged with a Dimension 3000 AFM (Veeco Instruments Inc., Plainview, N.Y.) using alternate contact mode cantilevers (No. OMCL-AC160TS-W2), 7 nm nominal tip radius, 15 nm tip height, 42 N m⁻¹ spring constant, Olympus, Center Valley, Pa.). Feature heights are measured by AFM according to the same approach as taken for measurement of dot, line and square feature heights during intensity measurements as described above. The AFM height is then compared to the height estimated from fluorescence intensity calibration curves.

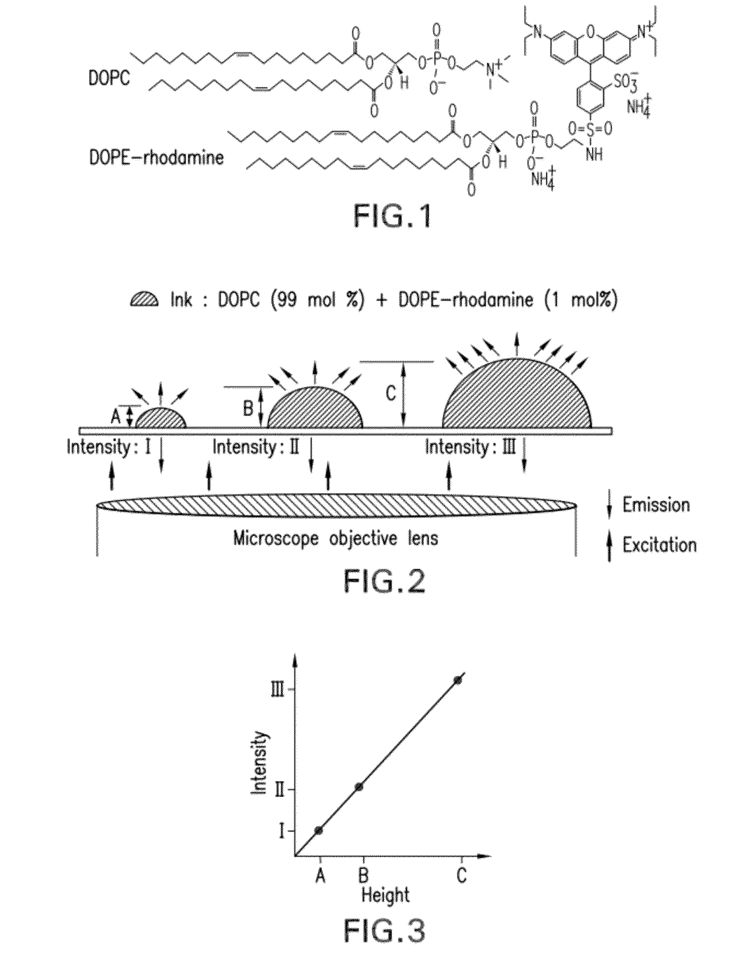

Results. FIGS. 1, 2 and 3 show a schematic diagram of the overall process of measuring the intensity of fluorescent lipid microstructures for determination of their height by fluorescence intensity using height calibration curves. FIG. 1 shows the chemical structures of the lipid molecules used to fabricate the calibration standards used in this example. In the first step, 1,2-dioleoyl-sn-glycero-3-phosphocholine (DOPC) is doped with 1 mol % red dye 1,2-dioleoyl-sn-glycero-3-phosphoethanolamine-N-(lissamine rhodamine B sulfonyl) (DOPE-RB) and patterned on a glass slide. Sequential images of the fluorescent lipid patterns were recorded, and the intensities (grey values, 0-255) of the features in each image (corresponding to each exposure time) are proportional to the feature height. As illustrated in FIG. 2, taller patterns have higher fluorescent intensity (I<II<III), as shown by the number of arrows over each feature, and appear brighter in the fluorescence image as shown with the three hypothetical dots of different heights (a≦b≦c). The intensity of each structure is measured after DPN with ImageJ software with intensity values ranging from 0 to 255 (for an eight-bit image). FIG. 3 shows the expected relationship between the feature height and the fluorescence intensity registered, with taller dots showing higher intensities.

Thus a calibration curve for the features can be drawn using the slope of FIG. 3 This results in a calibration curve of sensitivity (grey values/s) vs. the feature height. By measuring the feature intensity at a certain exposure time, it is possible to estimate the height of the fluorescent feature using the calibration curve. This allows rapid quality control of the patterned features, modification of the DPN parameters (if need be) and enables tunable control over the height of lipid microstructures.

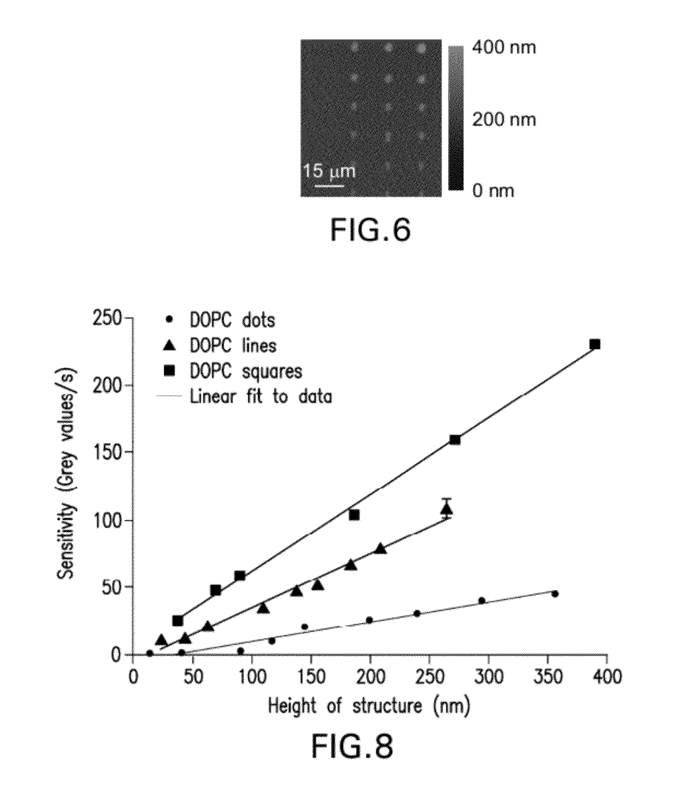

In order to demonstrate the relationship between feature height and recorded intensity, features in different shapes, i.e., dots, lines and squares, are created. For dots, pattern of 6×3 (15 μm pitch) dots with DOPC created using DPN with M type cantilevers is shown in FIGS. 4, 5, 6 and 7. FIG. 4 is the fluorescent micrograph of the dots. Dot intensities are measured as that of the brightest pixel in the dot. The dots are of different intensities indicating a difference in height. FIG. 5 is an intensity vs. exposure time curve for a 227 nm tall dot, indicated by an arrow in FIG. 4, obtained by measuring the fluorescent intensity of that dot using ImageJ over the various exposure times. FIG. 6 is an AFM height image of one of the dot arrays (dot radii 640 nm to 2.5 μm) enclosed in white rectangle in FIG. 4 having dot heights ranging from 14 to 356 nm. FIG. 7 is a sensitivity (grey values/s) vs. a dot height calibration curve for all the dot heights measured. Each of the data points in FIG. 7 is obtained by plotting the slope vs. the height measured with AFM. FIG. 7 shows the calibration curve obtained (grey values/s vs. dot height) using the intensity measurement over various exposure times. FIG. 7 also shows that higher features exhibit higher values of sensitivity (grey values/s) and need lower exposure times to reach the saturated intensity grey value (255).

How shape of the fluorescent microstructure affects the recorded intensity is also determined. In addition to arrays of dots, arrays of line-shaped fluorescent microstructures and arrays of square-shaped microstructures are created and the sensitivity vs. feature height calibration curves are obtained as shown in FIG. 8. The highest height obtained for dots is ˜350 nm while the highest height for lines and squares is ˜300 and ˜400 nm, respectively. However, the trend of lower features exhibiting lower intensity values is observed for all the three shapes. The three shapes have significantly different slopes: 0.087 for dots, 0.337 for lines and 0.587 grey values/s/nm for square patterns. The number of bright rhodamine dye molecules enclosed in the three shapes is different and this directly affects the sensitivity of measurement based on structure height.

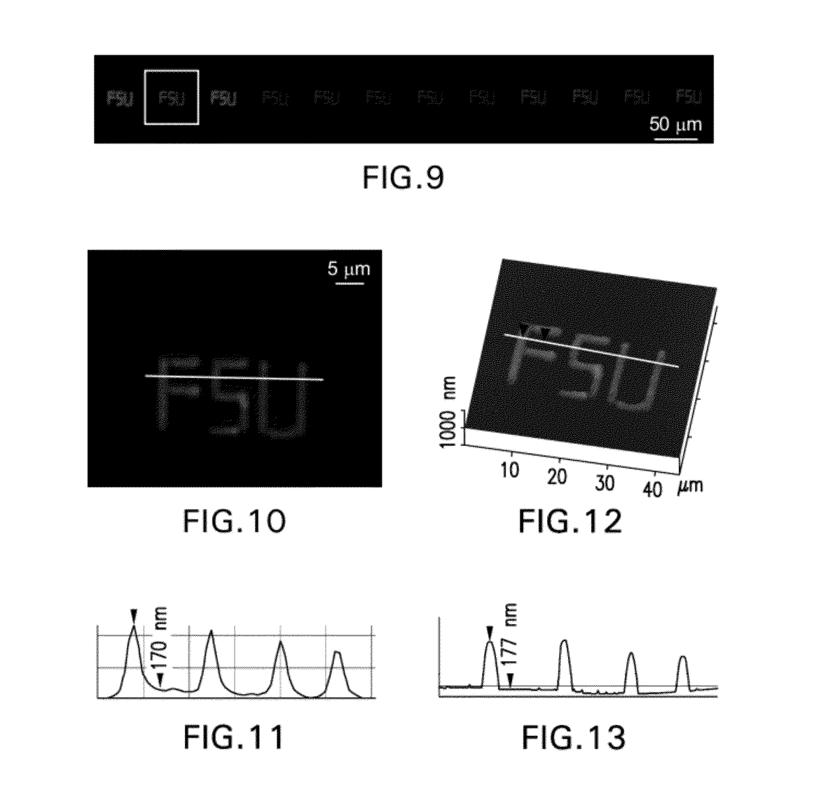

In order to test this approach of quantifying the feature height by using the florescence intensity of lipid features, the fluorescence intensity is used it to measure the height of a “FSU” pattern created with lines as shown in FIGS. 9, 10, 11, 12 and 13. The calibration curve used to measure the height of the FSU letters is the calibration curve obtained for the line patterns in FIG. 8, i.e., slope of 0.337 grey values/s/nm. The FSU pattern is created and imaged under the fluorescent microscope using the 10× objective lens over different exposure times (800 μs-8 s), and its height is immediately measured with tapping mode AFM. FIG. 9 is a fluorescent microscope image of a large area (0.12 mm²) FSU pattern created by moving the DOPC coated tip at a tip speed of 75 nm/s. FIG. 10 shows a close-up fluorescent microscope image of the FSU pattern imaged at 2 s exposure time. The height of the same “F” letter measured across the region denoted by the white line in FIG. 10 using the calibration curve of FIG. 11, is estimated to be ˜170 nm using Equation 1 below:

$$Height ( nm ) = \frac{Measuredintensity from fluorescence image ( grey values )}{\begin{matrix}Slopeof the line calibration curve ( grey values \text{/} s \text{/} nm ) * \\ Exposuretime ( s )\end{matrix}} = \frac{115}{0.337 * 2} = 170 \qquad ( 1 )$$

FIG. 12 is AFM height image of the same FSU logo of FIG. 10 at the same exposure time, i.e., 2 s, with a measurement performed at the same location of the white line as shown in FIG. 10. The height is measured to be 177 nm as shown in FIG. 13, while the height. The error between the estimated feature height obtained using Equation 1 and the measured height is with an error of ˜4%.

The actual feature heights of ten different measurements measured by AFM are compared to those estimated using the fluorescence intensity of the structures, and the differences are found to be within an average of 7%±4% of the feature heights measured with AFM. Further, the lowest height of the fluorescent microstructure that could be reproducibly quantified by this approach is ˜10 nm, which is the equivalent of three DOPC lipid bilayers (which are 3.5 nm).

This close matching of the estimated feature height (from calibration curves obtained using fluorescence intensity measurements) to the actual feature height obtained using AFM measurements in a different experiment validates this approach of using optical quality control to determine feature height. This control over height may be important in developing novel applications of lipid microstructures as diffraction gratings. Further, this nonintrusive optical approach may be extended to systems where the lipid microstructures can be envisioned to act as carriers of other biomaterials essential to understanding cell-structure relationships. With the base lipid feature height vs. intensity calibrated, it may be possible to estimate the amount of biomaterial carried with the lipid microstructure. This approach can also be extended to other similar liquid (lyotropic) biocompatible ink systems using optical quality control as the height determining method. Optical quality can be especially useful for large-area feature height determination where slow AFM scanning cannot be desirable.

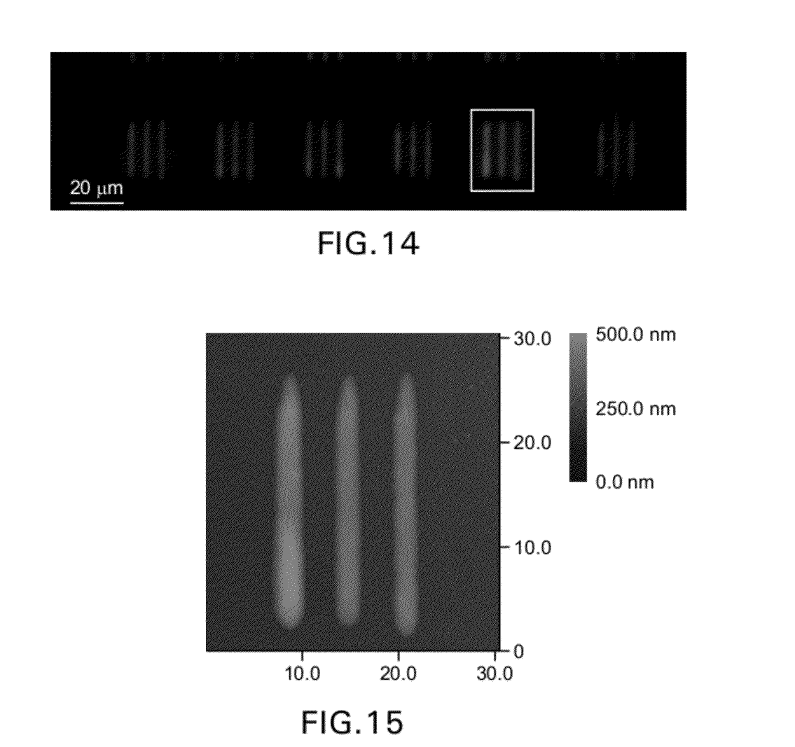

A pattern of DOPC line patterns created by parallel DPN (with each tip drawing an array of three parallel lines) is shown in FIGS. 14, 15 and 16. FIG. 14 is a fluorescent micrograph of line patterns drawn with doped DOPC ink, by moving the tip at a speed of 100 nm/s with the lines being 20 μm long. The average width of the lines is ˜300 nm.

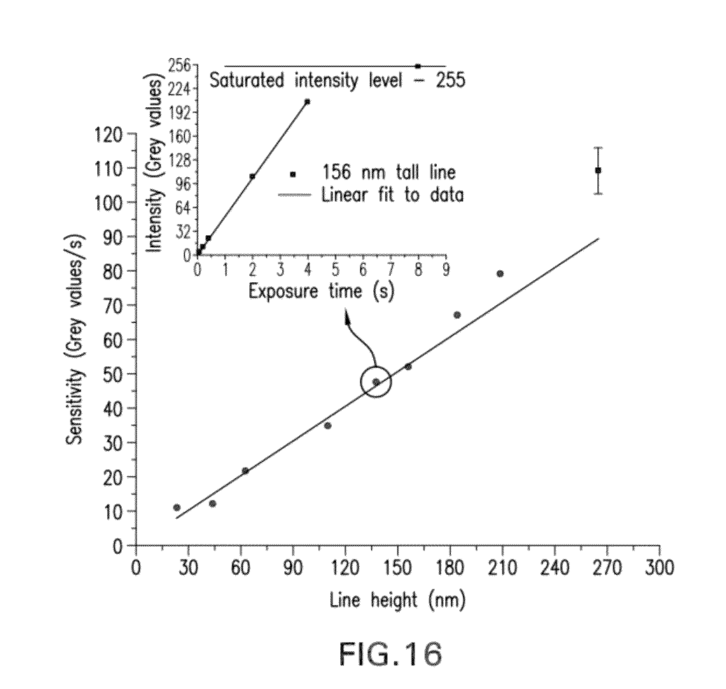

FIG. 14 is a fluorescence micrograph of the lines taken through a 10× objective lens. FIG. 15 shows the AFM height image of one representative line array. The average height of the lines is measured to be 304, 213 and 215 nm (left to right). FIG. 16 is a graph of sensitivity vs. a line height calibration curve obtained using the slope (grey values/s) of each line height with an inset graph shows a typical linear relationship observed between the exposure time (s) and intensity (grey values) registered for a 156 nm tall line. The saturated intensity level (255) is also shown as a horizontal line. Average width of the lines is ˜2.7 μm.

For purposes this example, the intensity of a feature is defined by the maximum intensity of a pixel within that feature; line fluorescence intensities were defined as that of the brightest pixel in a cross section of the line. Because different line heights require different exposure times to be within the dynamic range of the camera (so that large features would not be saturated while others were not visible), the same area is systematically imaged using different exposure times and plotted the intensity against exposure time. FIG. 16 (inset) shows such a plot for a 156 nm high line and indicates a linear dependence of line heights on fluorescence intensity measured over the exposure times. The slope of the relation between measured intensity and exposure time may be referred to as the “sensitivity” of each feature, and it has units of grey values s⁻¹. For example, the resulting sensitivity for a 156 nm tall line is 52 grey values s⁻¹ and is plotted as an inset in FIG. 16. A series of these fluorescence sensitivity and AFM height measurements for all the different line heights resulted in a calibration curve (sensitivity against height) as shown in FIG. 16, and a linear dependence is observed.

FIG. 17 is a fluorescent micrograph of square patterns drawn with doped DOPC ink.

FIG. 18 is an AFM height image of the square enclosed by the white square in FIG. 17, imaged in alternate contact mode.

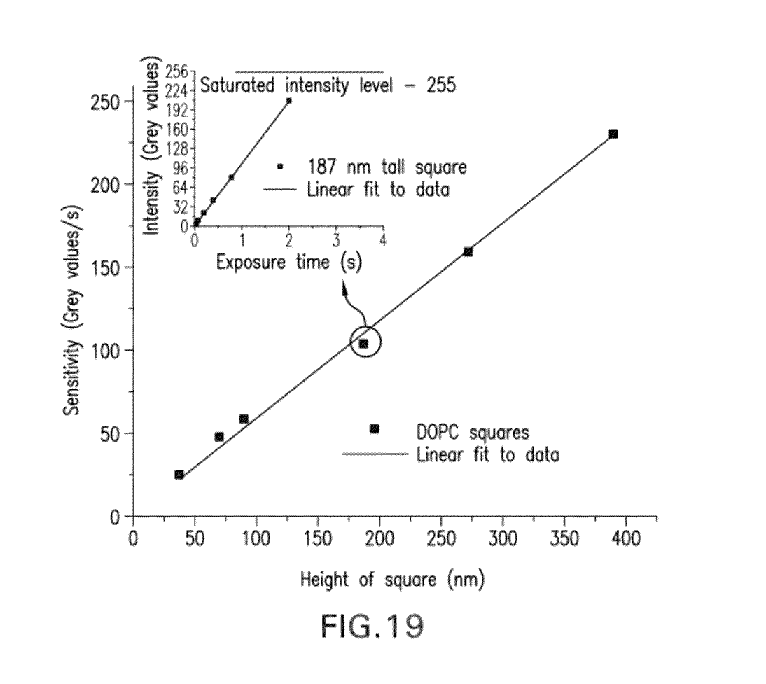

FIG. 19 is a graph of sensitivity vs. line height calibration curve obtained using the slope (grey values/s) of each line height with an inset graph showing a typical linear relationship observed between the exposure time (s) and intensity (grey values) registered for a 187 nm tall square. Square intensities are defined as the average intensity of the flat region within the square. The saturated intensity level (255) is shown as a horizontal line.

As discussed above, although a reliable linear trend is observed in which taller features showed higher intensities for all three shapes, the different structure geometries had significantly different slopes: 0.087±0.003 grey values s⁻¹ nm⁻¹ for dots, 0.337±0.012 for lines, and 0.587±0.009 for squares, as shown in FIG. 8. A possible explanation is a proximity effect, i.e., that light emitted from a single pixel-sized cross section of the surface is picked up by more than one pixel, thus leading to extra illumination per pixel for higher-dimensional structures, which would be described by the point spread function for the optical system being used. In order to estimate the lateral resolution of a fluorescence microscope, the Rayleigh criterion is typically used (d=0.61λ/NA, where d is the separation distance between emitters, is the wavelength of emitted light, and NA is the numerical aperture). In the case of the calibration shown in FIG. 8, with our 10× objective, there is a d of 1.16 μm, and therefore a rather large surface area is imaged by each pixel.

The use of higher NA optics may reduce this effect and provide insights into how sub-wavelength structures influence optical properties. As the aspect ratio of features can affect calibration, it is worth noting that aspect ratios (heights/widths) in constructive lithographic methods are typically low, and in the case of lipid DPN typically less than 0.1.

There also may be further structure-dependent effects. For example, one possibility is that the dye molecules have a preferred orientation within the liquid crystalline lipid structures that affects their optical cross sections and therefore absorption efficiencies. The difference in calibration responses for dots, lines and squares with these inks indicates that a reliable calibration will require use of a standard sample with the same types of structures as those to be fabricated. Worth noting is that all the linear fits go roughly through the origin; i.e., sensitivity is zero for a structure of height zero, so signal to background noise selectivity is good.

To test further the reliability of this characterization method, the curve of emission intensity plotted against dye concentration is investigated as a control. The intensity is found to increase linearly with dye concentration (0.125-2 mol %) for the same feature height. Because different objective lenses, with different NA, will collect different amounts of light, different objectives are calibrated by using the same lens to measure a set of dots of the same height using 4×, 10×, and 40× magnification lenses. As expected, the higher-magnification (and higher-numerical-aperture) lens collected more light per pixel and correspondingly exhibited higher calibration curves, i.e., steeper slope of the intensity plotted against exposure time.

Therefore, use DPN may be used to produce calibration standards for optical microscopy and these same standards may be used for the high-throughput determination of feature heights of lipid microstructures and nanostructures using a standard fluorescence microscope. Higher features correspond to greater intensity (grey values) registration, and this linear relationship can be used to determine the feature heights of subsequent patterns written with the same ink. This rapid height characterization method is not limited to DPN; any other micro/nano-patterning technique like micro-contact printing may also be used to create the fluorescent structures.

The optical response depends on the shape of the fluorescent microstructures such as dots, lines or squares. The rapid nonintrusive optical calibration and height estimation approach of some embodiments of the present invention extended to systems in which the lipid microstructures can be envisioned to act as carriers of other biomaterials essential to investigating microstructure-function and nanostructure-function relationships in lipids and biology in general. This optical quality-control approach may be especially useful for determining the height of large-area features, where AFM scanning is not practical. For example, systems where this approach is promising include the analysis of ultrasmall liquid droplets, matrix-assisted dip-pen nanolithography, polymer-pen lithography, and especially the characterization of lipid structures.

Having described the many embodiments of the present invention in detail, it will be apparent that modifications and variations are possible without departing from the scope of the invention defined in the appended claims. Furthermore, it should be appreciated that all examples in the present disclosure, while illustrating many embodiments of the invention, are provided as nonlimiting examples and are, therefore, not to be taken as limiting the various aspects so illustrated.

While the present invention has been disclosed with references to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A device comprising:
a substrate, and
one or more patterned arrays of fluorescent microstructures on the substrate,
wherein each of the one or more patterned arrays of fluorescent microstructures comprises fluorescent microstructures having the same shape and two or more different heights.

2. The device of claim 1, wherein the fluorescent microstructures comprise fluorescent nanostructures.

3. The device of claim 1, wherein the one or more patterned arrays of fluorescent microstructures comprise a patterned array of dots having two or more different heights and/or a patterned array of lines having two or more different heights and/or a patterned array of squares having two or more different heights.

4. The device of claim 1, wherein the fluorescent microstructures comprise biomolecules.

5. The device of claim 4, wherein the biomolecules comprise phospholipids.

6. The device of claim 1, wherein the fluorescent microstructures comprise multilayer structures.

7. The device of claim 1, wherein at least one of the one or more patterned arrays of fluorescent microstructures comprises a patterned array of dots having two or more different heights.

8. The device of claim 1, wherein at least one of the one or more patterned arrays of fluorescent microstructures comprises a patterned array of lines having two or more different heights.

9. The device of claim 1, wherein at least one of the one or more patterned arrays of fluorescent microstructures comprises a patterned array of squares having two or more different heights.

10. The device of claim 1, wherein at least two of the one or more patterned arrays of fluorescent microstructures comprise at least two different members of the group consisting of a patterned array of dots, a patterned array of lines and a patterned array of squares.

11. A method comprising the following steps:
(a) calibrating a camera based on a calibration profile,
(b) detecting with the calibrated camera fluorescent intensities of one or more fluorescent microstructures of a sample, and
(c) determining a height of each of one or more fluorescent microstructures of the sample based on the fluorescent intensities detected in step (b),
wherein the calibration profile is based on fluorescence intensities detected by the camera for one or more patterned arrays of standard fluorescent microstructures of a calibration standard, and
wherein each of the patterned arrays of standard fluorescent microstructures comprises fluorescent microstructures having the same shape and two or more different heights.

12. The method of claim 11, wherein the one or more fluorescent microstructures of the sample and/or patterned array of standard fluorescent microstructures of the calibration standard comprise fluorescent nanostructures.

13. The method of claim 11, wherein the method comprises the following step:
(d) detecting with the camera the fluorescent intensities for at least one of the one or more patterned arrays of the standard fluorescent microstructures of the calibration standard.

14. The method of claim 11, wherein the one or more patterned arrays of standard fluorescent microstructures comprise a patterned array of dots having two or more different heights and/or a patterned array of lines having two or more different heights and/or a patterned array of squares having two or more different heights.

15. The method of claim 11, wherein the fluorescent microstructures comprise biomolecules.

16. The method of claim 15, wherein the biomolecules comprise one or more phospholipids.

17. A method comprising the following steps:
(a) detecting with a camera fluorescent intensities of one or more fluorescent microstructures of a sample, and
(b) determining a height of each of the one or more fluorescent microstructures based on the fluorescent intensities detected in step (a) and a calibration profile for the camera,
wherein the calibration profile is based on fluorescence intensities detected by the camera for one or more patterned arrays of standard fluorescent microstructures of a calibration standard, and
wherein each of the patterned arrays of fluorescent microstructures comprises fluorescent microstructures having the same shape and two or more different heights.

18. The method of claim 17, wherein the one or more fluorescent microstructures of the sample and/or patterned array of standard fluorescent microstructures of the calibration standard comprise fluorescent nanostructures.

19. The method of claim 17, wherein the method comprises the following step:
(c) detecting with the camera the fluorescent intensities for at least one of the one or more standard fluorescent microstructures of the calibration standard.

20. The method of claim 17, wherein the one or more patterned arrays of standard fluorescent microstructures comprise a patterned array of dots having two or more different heights and/or a patterned array of lines having two or more different heights and/or a patterned array of squares having two or more different heights.

21. The method of claim 17, wherein the fluorescent microstructures comprises biomolecules.

22. The method of claim 21, wherein the biomolecules comprise one or more phospholipids.

23. A method comprising the following steps:
(a) providing a substrate, and
(b) depositing one or more patterned arrays of fluorescent microstructures on the substrate,
wherein each of the patterned array of fluorescent microstructures comprises fluorescent microstructures having the same shape and two or more different heights.

24. The method of claim 23, wherein fluorescent microstructures comprise fluorescent nanostructures.
